(19) United States
(12) Patent Application Publication
(10) Pub. No.: US 2002/0188440 A1
(43) Pub. Date: Dec. 12, 2002

(54) Optimized MPEG-2 encoding for computer-generated output

(76) Inventors: Mark J. Foster, Palo Alto, CA (US); James Jay Kistler, San Jose, CA (US)

Correspondence Address: GLENN PATENT GROUP, 3475 EDISON WAY, SUITE L, MENLO PARK, CA, 94025, US

(21) Appl. No.: 09/844,162

(22) Filed: Apr. 27, 2001

(51) Int. Cl. G10L 19/00

(52) U.S. Cl. 704/200.1

(57) ABSTRACT

A method and apparatus is provided that significantly enhances the performance of MPEG-2 encoding for computer-output applications by easily distinguishing between situations where temporal coding is useful, and situations where it is unnecessary.

### BACKGROUND OF THE INVENTION

1. Technical Field

The invention relates to signal encoding. More particularly, the invention relates to optimized MPEG-2 encoding for computer-generated output.

2. Description of the Prior Art

As cable television systems become increasingly sophisticated, a growing number of applications are being developed to deliver formatted video output to set-top boxes in the form of an MPEG-2 formatted data stream, using the set-top box's internal MPEG decoder to create the actual video. Most such systems today use hardware MPEG-2 encoder ICs, although the advent of very high performance microcomputers is beginning to make software MPEG-2 encoding possible. One such system is that developed by Agile TV Corporation of Menlo Park, Calif. In this system, general purpose processors are used and directly produce MPEG-2 encoded video (see, for example (Calderone et al., “SYSTEM AND METHOD OF VOICE RECOGNITION NEAR A WIRELINE NODE OF A NETWORK SUPPORTING CABLE TELEVISION AND/OR VIDEO DELIVERY”, U.S. patent application Ser. No. 09/785,375, fled Feb. 16, 2001, attorney docket no. AGLE0001). Specifically, Internet content is converted into the MPEG-2 format to allow dumb set-top boxes to deliver Web-based content.

One downside of MPEG-2 encoding for such application is that MPEG-2 is actually optimized for motion video. However, the nature of most browser output is that it is predominantly static in nature, i.e. after a page is rendered on top of the screen, most of content of the page does not change. As a result, much of the processing overhead used for MPEG-2 encoding is wasted looking for changes in images that do not, in fact, change.

It would be advantageous to provide a method and apparatus that enhances the performance of MPEG-2 encoding for computer-output applications by easily distinguishing between situations where temporal coding is useful, and situations where it is unnecessary.

### SUMMARY OF THE INVENTION

The herein disclosed invention significantly enhances the performance of MPEG-2 encoding for computer-output applications by easily distinguishing between situations where temporal coding is useful, and situations where it is unnecessary. The invention herein disclosed exploits the fact that a computer that is generating output reduces dramatically the workload required to produce an MPEG stream. In the presently preferred embodiment of the invention, the output of a browser produces a frame of video, although the invention is readily applied to any other computer application, e.g. a game.

A key insight of the invention is that when a computer generates information versus video that is generated in a typical MPEG device, the computer knows what area of a display is changing and, therefore, must be updated. In other words, as objects are rendered to the display, the invention provides a mechanism that defines a polygonal region which encompasses that update. In a preferred embodiment, the region is a rectangular region that is identified by the XY coordinates of the corners or XY plus [size size]. In so doing, the translation can be dramatically simplified.

### BRIEF DESCRIPTION OF THE DRAWINGS

FIG. 1 is a block schematic diagram which shows a conventional MPEG encoder;

FIG. 2 is a flow diagram showing a mechanism for optimized MPEG-2 encoding for computer-generated output according to the invention; and

FIG. 3 is a flow diagram showing a mechanism for creating a P-frame according to the invention.

### DETAILED DESCRIPTION OF THE INVENTION

An increasing number of services are delivered to digital cable set-top boxes. For such services, MPEG-2 is the clear transport stream of choice because there currently is an installed base of tens of millions of set-boxes that can receive that stream. Of the streams that are delivered to these set-top boxes, an increasing number are computer generated, e.g. a Web page, as compared to video generated, i.e. television programming.

MPEG-2 is clearly optimized for video use and, yet, there are ever more applications that must produce an MPEG-2 stream, starting with a computer.

The invention herein disclosed exploits the fact that a computer that is generating the output reduces the workload required to produce an MPEG stream dramatically. In the presently preferred embodiment of the invention, the output of a browser produces a frame of video, although the invention is readily applied to any other computer application, e.g. a game.

A key insight of the invention is that when a computer generates information versus video that is generated in a typical MPEG device, the computer knows what area of a display is changing and, therefore, must be updated. In other words, as objects are rendered to the display, the invention provides a mechanism that defines a polygonal region which encompasses that update. In a preferred embodiment, the region is a rectangular region that is identified by the XY coordinates of the corners or XY plus [size size]. In so doing, the translation can be dramatically simplified.

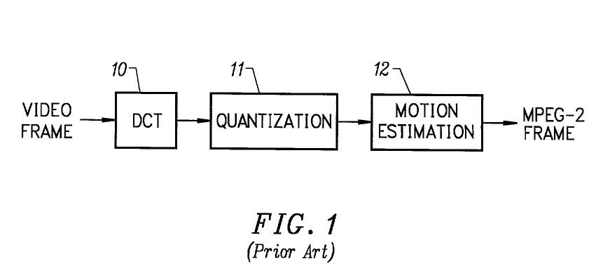

FIG. 1 is a block schematic diagram which shows a conventional MPEG encoder. In a conventional MPEG encoder, the first frame of a video sequence is compressed by applying a discrete cosine transform (DCT) 10, then quantization 11, where the quantizer coefficients actually provide the compression. The compressed output, augmented by various overhead information, represents the state of a single frame of the video stream, and is referred to as the I-frame. Temporal compression 12 follows. This occurs by comparing subsequent video frames to the initial reference frame, by exploiting a bandwidth-intensive motion estimation search which identifies how small regions of the image have moved between frames. These subsequent frames encode changes between the current frame and the most recent I-frame. This output is referred to as a P-frame (a predicted frame) or a B-frame (a bi-directional interpolated frame). For a further discussion of MPEG, see B. Haskell, A. Puri, A. Netravali, Digital Video: An Introduction to MPEG-2, Kluwer Academic Publishers (1997).

In a largely static display application, such as conventional Internet browsing, the browser display often remains unchanged for many frames of video, leading to intensive compute and bandwidth use by the motion estimation scheme without any apparent benefit.

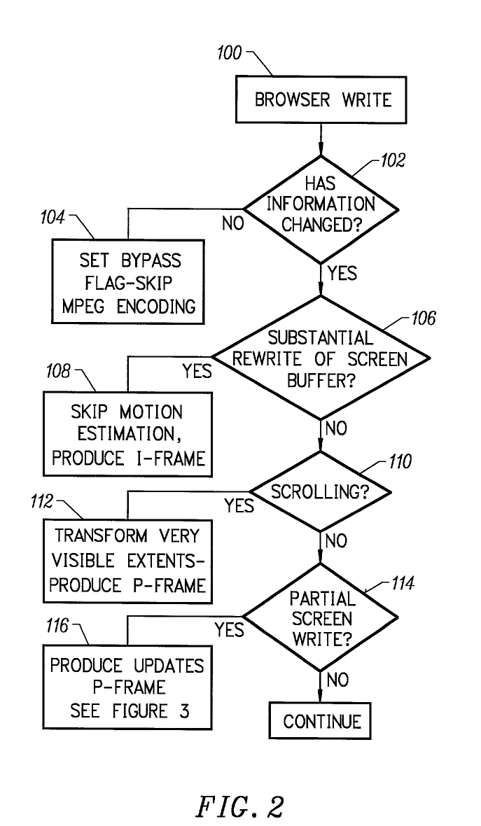

FIG. 2 is a flow diagram showing a mechanism for optimized MPEG-2 encoding for computer-generated output according to the invention.

A first aspect of the herein disclosed invention is to provide a memory flag (104) that is written each time the browser writes (100) new information to the screen. This flag enables the system to bypass MPEG encoding completely if the information has not changed (102). The flag is set upon each entry into the GDI-Level drawing routines.

A second aspect of the herein disclosed invention augments the layer of software that writes to the screen buffer such that the extent of the area being written is checked. In other words, whenever the system software updates the screen buffer, the drawing layer of the software checks to see the size of the data that are to be written (106). By so doing, it becomes possible to predict whether it is possible to render a changed image most efficiently as a new MPEG I-frame, or as a P-frame or B-frame. When substantial portions of the image are rewritten, it is possible to skip the motion estimation phase and directly produce an I-frame (108). When smaller regions of the display change, the motion estimation phase is performed, allowing the generation of more bandwidth-efficient P-frames or B-frames. For example:

| | |
|---|---|
| If (MINY > X) MINX = X | If (MAXX < X) MAXX = X |
| If (MINY > Y) MINY = Y | If (MAXY < Y) MAXY = Y |
| AREA = (MAXX − MINX) * | |
| (MAXY − MINY) | |
| IF AREA > MAGIC NUMBER, THEN. . . | |

A third aspect of the herein disclosed invention takes advantage of browser scrolling (110. When a user issues a scroll command, either a vertical command or a horizontal command, to the browser, it is possible to compute directly the change in each block. This is because the browser contains in its memory a representation of the whole page. The scrolling action corresponds to transforming the visible extents in either the X or Y dimension (112). The result is a very computationally efficient method for computing P-frames, which in turn greatly reduces the bandwidth that must be transmitted. To accomplish this, the system transmits a P-frame which says to move all macroblocks “II” in the scroll direction by the number of pixels desired then encode the new macroblocks for the “new” area.

In summary, by intelligently analyzing the screen updates performed by a computer outputting images, it is possible to transform these images into an MPEG-2 format much more efficiently than would otherwise be possible.

A fourth aspect of the herein disclosed invention exploits the fact that screen updates are generated by a computer in a Web browser application, and thus affect specific regions of the screen (114), as opposed to traditional methods of encoding full-screen video. As discussed above, full motion estimation is only performed on regions of the screen that had been updated (116). For example, if a rectangular region of the screen bounded by pixel coordinates (0,50)-(100,100) is written to, then only these areas are scanned for motion estimation purposes. In reality, with non-video computer applications, a screen update to a specified region of the screen is very likely to be quite different than the original material. As a result, it is expected that little benefit is derived from applying motion estimation in most cases. Because the process of computing motion estimation is extremely computationally expensive, one embodiment of the invention eschews the use of motion estimation for non-video screen updates.

For terms of clarification, it is important to understand that MPEG frames are generated out of a sequence of macroblocks, which are small regions of the screen that are treated as a single unit. In MPEG-2, macroblocks are defined as 8 by 8 pixel groups. Therefore, the screen buffer effectively may be viewed as being (horizontal dimension)/8 macroblocks wide by (vertical dimension)/8 blocks high.

In the case of small partial screen updates, e.g. less than a heuristic value of, for example, 30% of the total screen area, a partial frame update is performed by generating an MPEG-2 P-frame.

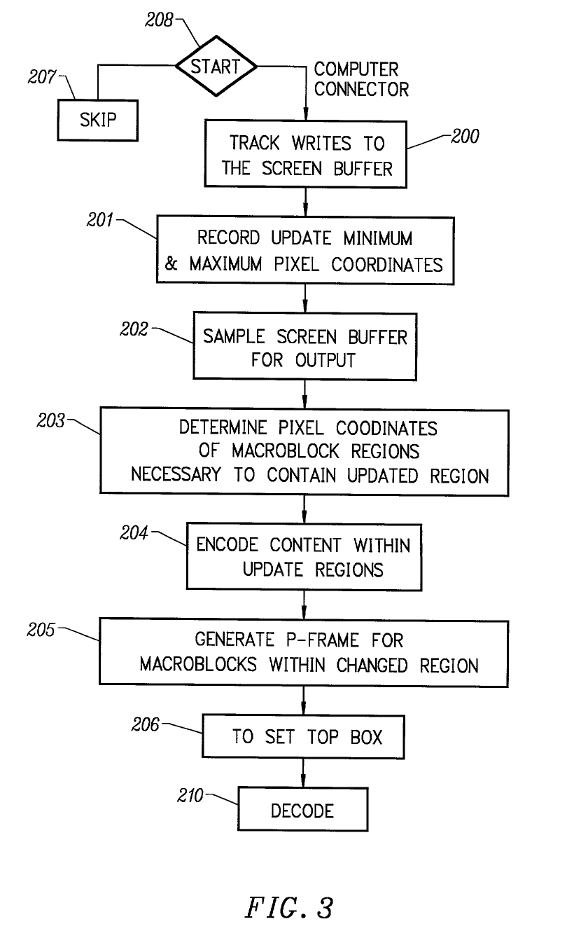

FIG. 3 is a flow diagram showing a mechanism for creating a P-frame according to the invention. To create a P-frame in accordance with this aspect of the invention, the following steps are performed:

1. Writes to the screen buffer are tracked (200), such that the minimum and maximum pixel coordinates being updated are recorded (201). Either a single update region may be tracked, containing the minimum and maximum pixel coordinates of all screen updates with the specified interval, or a list of update regions may be created. These min/max coordinates serve to guide subsequent MPEG generation intelligibility.

2. After a screen update occurs, but not more frequently than, for example, fifteen times/second, the screen buffer is sampled for output (202).

3. For each of the screen regions being tracked, the following are applied:

a. Determine the pixel coordinates of the macroblock regions that are necessary to contain the window boundary of the updated region total (203). For example, if the regions from (13,50)-(69,100) are modified, the macroblocks fully representing the update region have screen coordinates from (8,48)-(71,103).

b. The content in the updated regions is encoded via the usual DCT, quantization, and run-length encoding steps used in MPEG (204).

c. A P-frame is generated, specifying that only the transformed macroblocks that are to be replaced (205).

d. Within the set-top box (206), the MPEG decoder transforms the received serial data stream (210) in such a way that the display region from (8,48)-(71,103) is written with the new content, e.g. the macroblock coordinates are included in the MPEG stream.

For multimedia content containing video (208), this process is not applied (207) because the multimedia information does not flow thorough the browser, but rather “flies by” external to the browser.

The following discussion concerns various rendering states and the presently preferred mechanism for handling them.

In a first state, substantially the entire display is updated. Beyond some heuristic threshold, e.g. 50% (or as otherwise experimentally devised), the system determines that there is no point in trying to perform motion compensation on the updated image, and the system generates a new MPEG I-frame to replace the frame currently displayed. For example, if a user is browsing the Web and moves to an entirely different site, e.g. from YAHOO.com to EBAY.com, it is more computationally efficient and introduces less latency if the entire frame is replaced. In this case, where substantially all of the information is rewritten, the system immediately signals the MPEG encoder to generate an I-frame, e.g. by passing a “motion-comp” flag and an “I-frame” flag, such that “I-frame-tree”. This skips the enormously computationally intensive motion estimation phase. Accordingly, a key aspect of the invention is skip the motion estimation phase of MPEG encoding whenever possible because it is so computationally expensive. As discussed above, one instance where this is possible is when materially all of the information on the display is rewritten.

Thus, a first optimization for Web-based or Internet-based MPEG is that the system is instructed not to perform motion estimation if a new display is to be written.

Zero the optimization? Do not send anything, but timestamp if the image has not changed.

A second state occurs where not substantially all, but a bounded region of the display, is changing, e.g. GIF animations. In this case, it is only necessary to perform motion estimation within that bounded region. In this case, the system looks for regions of change, which correspond to the only area of the display that has been updated. For all other regions, the system completely skips macroblock encoding and many other of steps in the MPEG encoding process. For example, macroblock generation and DCT transformation do not have to be performed because all of the macroblocks in those other regions did not change.

In this optimization, the region that is the outer region encompassing the area which did change, for example a macroblock region which is updated and therefore has to change, goes through the full MPEG encoding process. The other regions that did not change, and that can be previously stored if desired, have all been previously encoded. In fact, the system can encode the information for the portion of the frame that has changed as a partial frame.

In this optimization, the system transmits the changed region only as a P-frame, completely skipping all the analysis on the remainder of the frame because there is no need to update any of the other portions of the frame.

Accordingly, only new data are sent.

A third state occurs when the user executes a scrolling function. For scrolling purposes, information is essentially written to all of the display. This aspect of the invention exploits the fact that the computer has knowledge of the scroll request. For example, when a user is scrolling upward it is necessary to regenerate a bottom region of the display but none of the other macro blocks have to change. By working on a macroblock boundary, it is possible to perform such scrolling with minimal computation. Nothing is checked. The system only regenerates new band at the bottom of the display. Thus, individual motion vectors are sent for each macroblock being scrolled. This approach is very efficient because essentially zero overhead is required to send these macroblocks.

In this optimization, a single motion vector is applied simultaneously to all of the blocks within the moved portion of the display during the scrolling operation. While it is true that the motion vector is the same for each block, the most significant savings comes from “knowing” this, rather than being able to send 1 number.

Further extensions to this invention advantageously support rapid transfer of data between the head-end controller and the set-top box, by using an MPEG Video Program Elementary Stream to encode arbitrary values. This is accomplished via one of two embodiments.

In the first embodiment, a new system of quantizer transformations is employed between the transmitter and the receiver, to make the data transmission process effectively lossless. By removing all zero elements from the quantizer table, and by coding quantizer values such that the overall system transfer function is nearly lossless, minimal distortion is applied to data which flows through the video encoding and decoding path. This semi-lossless quantizer table is transmitted to the set-top box for decode purposes. To correct for data distortion due to the dead zone that occurs during decoding of non-intra frames, it is possible to pre-distort the source data prior to the MPEG encoding process in such a manner that the source data may successfully be reconstructed following MPEG decoding. In the first embodiment, the hardware in the set-top box retrieves MPEG-decoded data from the screen buffer, following hardware decoding of the MPEG data into the screen buffer. Then, software in the set-top box performs the post-distortion mapping of the output data in such a manner that it matches the original form. To ensure that the video stream is not interrupted, control software in the set-top box temporarily blanks the screen while waiting for reception of a program fragment. This sequence is initiated via a separate command sent from the transmitter to the receiver.

The second embodiment for downloading data in a PES video stream is to place the data directly into the stream without MPEG encoding, and then to allow the set-top box to intercept the video data stream prior to display decoding. This is performed by encoding a DTS (Decoding Time Stamp) into the video stream which effectively represents a point far in the future. By doing so, the MPEG decoder places the data contents in the set-top boxes MPEG receive buffers, but inhibits application of hardware decoding until that future point occurs. Because software in the set-top box removes the buffer contents from the receive buffer well before the specified PTS time, the data are never presented to the MPEG decoder. This has two advantages compared to the first embodiment. To begin with, because the MPEG decoder never sees the packet, raw data may be placed directly into the program stream—it is not necessary to insert MPEG formatting fields to ensure conformance with the MPEG specification. The other benefit of the second embodiment is that no mathematical errors are introduced, so it is not necessary to pre-distort or post-distort the data stream i.e. no quantization is performed whatsoever, because neither MPEG encoding nor MPEG decoding occurs.

As a final step (regardless of the approach taken to transport the data to the set-top box) software in the set-top box performs a CRC check to ensure that the data have been successfully retrieved. If the check passes, the data may be used for subsequent processing and/or execution.

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. An apparatus for optimized MPEG-2 encoding for computer-generated output, comprising:
a mechanism for defining a region which encompasses an update to an MPEG frame that is a subset of the MPEG frame; and
an MPEG encoder for encoding only said region.

2. An MPEG encoder, comprising:
a discrete cosine transform (DCT) and quantization module for compressing a first frame of a video sequence, wherein a compressed output represents at least a state of a reference frame of a video stream;
a temporal compression module for comparing subsequent video frames to said reference frame with a motion estimation search which identifies how far regions of an image have moved between frames, wherein said subsequent frames encode changes between a current frame and a most recent reference frame; and
a mechanism for bypassing MPEG encoding completely if information in said image has not changed.

3. An MPEG encoder, comprising:
a discrete cosine transform (DCT) and quantization module for compressing a first frame of a video sequence, wherein a compressed output represents a state of a reference frame of a video stream;
a temporal compression module for comparing subsequent video frames to said reference frame with a motion estimation search which identifies how far regions of an image have moved between frames, wherein said subsequent frames encode changes between a current frame and a most recent reference frame; and
a mechanism for skipping said temporal compression module and directly producing any of a reference frame, a P-frame, and a B-frame, when substantial portions of said image are rewritten.

4. An MPEG encoder, comprising:
a discrete cosine transform (DCT) and quantization module for compressing a first frame of a video sequence, wherein a compressed output represents a state of a reference frame of a video stream;
a temporal compression module for comparing subsequent video frames to said reference frame with a motion estimation search which identifies how far regions of an image have moved between frames, wherein said subsequent frames encode changes between a current frame and a most recent reference frame; and
a mechanism for transforming visible extents of said image in either an X or a Y dimension in response to a scrolling action.

5. An MPEG encoder, comprising:
a discrete cosine transform (DCT) and quantization module for compressing a first frame of a video sequence, wherein a compressed output represents a state of a reference frame of a video stream;
a temporal compression module for comparing subsequent video frames to said reference frame with a motion estimation search which identifies how far regions of an image have moved between frames, wherein said subsequent frames encode changes between a current frame and a most recent reference frame; and
a mechanism for performing a partial frame update.

6. The encoder of claim 5, wherein said mechanism comprises:
a module for tracking writes to a screen buffer are tracked, wherein minimum and maximum pixel coordinates being updated are recorded and wherein, alternatively, either a single update region is tracked, containing minimum and maximum pixel coordinates of all screen updates with a specified interval, or a list of update regions is created;
a module for sampling said screen buffer for output after a screen update occurs; and
a module for applying the following for each screen region being tracked:
determining pixel coordinates of macroblock regions that are necessary to contain a window boundary of an updated region total;
encoding content in said updated regions in accordance with a standard MPEG encoding scheme; and
generating a P-frame specifying only those transformed macroblocks that are to be replaced;
wherein an MPEG decoder may transform a received data stream in such a way that a changed display region is written with new content.

7. An MPEG encoder, comprising:
a discrete cosine transform (DCT) and quantization module for compressing a first frame of a video sequence, wherein a compressed output represents a state of a reference frame of a video stream;
a temporal compression module for comparing subsequent video frames to said reference frame with a motion estimation search which identifies how far regions of an image have moved between frames, wherein said subsequent frames encode changes between a current frame and a most recent reference frame;
a mechanism for bypassing MPEG encoding completely if information in said image has not changed;
a mechanism for skipping said temporal compression module and directly producing a reference frame when substantial portions of said image are rewritten;
a mechanism for transforming visible extents of said image in either an X or a Y dimension in response to a scrolling action; and
a mechanism for performing a partial frame update.

8. An MPEG encoder, comprising:
a discrete cosine transform (DCT) and quantization module for compressing a first frame of a video sequence, wherein a compressed output represents a state of a reference frame of a video stream;
a temporal compression module for comparing subsequent video frames to said reference frame with a motion estimation search which identifies how far regions of an image have moved between frames, wherein said subsequent frames encode changes between a current frame and a most recent reference frame; and
an optimization mechanism for providing any of:
a first optimization for Web-based or Internet-based MPEG wherein said encoder is instructed not to perform motion estimation if substantially all of a new display is to be written;
a second optimization wherein said encoder transmits a changed region only as a P-frame, completely skipping all analysis on a remainder of said frame because there is no need to update any of the other portions of said frame; and
a third optimization wherein a single motion vector is applied simultaneously to all blocks within a moved portion of a display during a scrolling operation.

9. A method for optimized MPEG-2 encoding for computer-generated output, comprising the steps of:
defining a region which encompasses an update to an MPEG frame that is a subset of the MPEG frame; and
encoding only said region.

10. An MPEG encoding method, comprising the steps of:
compressing a first frame of a video sequence, wherein a compressed output represents a state of a reference frame of a video stream;
comparing subsequent video frames to said reference frame with a motion estimation search which identifies how far regions of an image have moved between frames, wherein said subsequent frames encode changes between a current frame and a most recent reference frame; and
bypassing MPEG encoding completely if information in said image has not changed.

11. A MPEG encoding method, comprising the steps of:
compressing a first frame of a video sequence, wherein a compressed output represents a state of a reference frame of a video stream;
comparing subsequent video frames to said reference frame with a motion estimation search which identifies how far regions of an image have moved between frames, wherein said subsequent frames encode changes between a current frame and a most recent reference frame; and
skipping said temporal compression module and directly producing a reference frame when substantial portions of said image are rewritten.

12. A MPEG encoding method, comprising the steps of:
compressing a first frame of a video sequence, wherein a compressed output represents a state of a reference frame of a video stream;
comparing subsequent video frames to said reference frame with a motion estimation search which identifies how far regions of an image have moved between frames, wherein said subsequent frames encode changes between a current frame and a most recent reference frame; and
transforming visible extents of said image in either an X or a Y dimension in response to a scrolling action.

13. An MPEG encoding method, comprising the steps of:
compressing a first frame of a video sequence, wherein a compressed output represents a state of a reference frame of a video stream;
comparing subsequent video frames to said reference frame with a motion estimation search which identifies how far regions of an image have moved between frames, wherein said subsequent frames encode changes between a current frame and a most recent reference frame; and
performing a partial frame update.

14. The encoder of claim 13, wherein said partial frame update comprises the steps of:
tracking writes to a screen buffer, wherein minimum and maximum pixel coordinates being updated are recorded and wherein, alternatively, either a single update region is tracked, containing minimum and maximum pixel coordinates of all screen updates with a specified interval, or a list of update regions is created;
sampling said screen buffer for output after a screen update occurs; and
applying the following for each screen region being tracked:
determining pixel coordinates of macroblock regions that are necessary to contain a window boundary of an updated region total;
encoding content in said updated regions in accordance with a standard MPEG encoding scheme; and
generating a P-frame specifying only those transformed macroblocks that are to be replaced;
wherein an MPEG decoder may transform a received data stream in such a way that a changed display region is written with new content.

15. An MPEG encoding method, comprising the steps of:
compressing a first frame of a video sequence, wherein a compressed output represents a state of a reference frame of a video stream;
comparing subsequent video frames to said reference frame with a motion estimation search which identifies how far regions of an image have moved between frames, wherein said subsequent frames encode changes between a current frame and a most recent reference frame;
bypassing MPEG encoding completely if information in said image has not changed;
skipping said temporal compression module and directly producing a reference frame when substantial portions of said image are rewritten;
transforming visible extents of said image in either an X or a Y dimension in response to a scrolling action; and
performing a partial frame update.

16. An MPEG encoding method, comprising the steps of:
compressing a first frame of a video sequence, wherein a compressed output represents a state of a reference frame of a video stream;
comparing subsequent video frames to said reference frame with a motion estimation search which identifies how far regions of an image have moved between frames, wherein said subsequent frames encode changes between a current frame and a most recent reference frame; and
providing an optimization mechanism for performing any of:
a first optimization for Web-based or Internet-based MPEG wherein said encoder is instructed not to perform motion estimation if a new display is to be written;
a second optimization wherein said encoder transmits a changed region only as a P-frame, completely skipping all analysis on a remainder of said frame because there is no need to update any of the other portions of said frame; and
a third optimization wherein a single motion vector is applied simultaneously to all blocks within a moved portion of a display during a scrolling operation.
